(19) United States
(12) Patent Application Publication
(10) Pub. No.: US 2017/0344986 A1
(43) Pub. Date: Nov. 30, 2017

(54) Systems and Methods for Propagating Messages Associated With Payment Transactions

(71) Applicant: MASTERCARD INTERNATIONAL INCORPORATED, Purchase, NY (US)

(72) Inventors: Saravana Perumal Shanmugam, Fremont, CA (US); Adam Kenneth Hosp, Lake St. Louis, MO (US); Siddique Hameed, Chesterfield, MO (US); Andrew J. Smith, St. Louis, MO (US)

(21) Appl. No.: 15/168,934

(22) Filed: May 31, 2016

(51) Int. Cl. G06Q 20/40; H04L 29/06; G06Q 50/00

(52) U.S. Cl. CPC G06Q 20/40; G06Q 50/01; H04L 63/10

(57) ABSTRACT

Systems and methods are provided for use in creating, distributing, and displaying messages. One exemplary method includes receiving, by a computing device, a message request associated with an event and extracting, by the computing device, payment information and message information from the request. The method also includes causing the payment information to be processed. The method further includes creating, by the computing device, a message feed related to the event, when such a message feed does not exist, and adding the message information to the message feed when the message feed exists. Finally, the method includes causing, by the computing device, in response to a message feed request, the message feed to be delivered, whereby the message feed is displayed at an event merchant associated with the event.

### FIELD

The present disclosure generally relates to systems and methods for propagating messages from consumers to one or more causes or events or locals, in association with payment transactions by the consumers.

### BACKGROUND

This section provides background information related to the present disclosure which is not necessarily prior art.

Products (e.g., goods, services, etc.) are known to be offered for sale, and to be sold, by merchants. Consumers are known to purchase such products using payment accounts. Separately, users of social media may make posts of text messages and, optionally, images, which are served or displayed to other people via the Internet or similar networks. In order to enable the posts to be seen by a large audience, the poster may include “hashtags,” which are keywords that enable aggregation of social media posts pertaining to the same or similar topics. A user of social media may make posts supporting various organizations and/or events (charitable or otherwise) that they feel are important.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for processing payment account transactions and for distributing messages in association with such transactions;

FIG. 2 is a block diagram of a computing device that may be used in the exemplary system of FIG. 1;

FIG. 3 is an exemplary method, which may be implemented in connection with the system of FIG. 1, for creating messages, in association with payment account transactions, and for then distributing the messages;

FIG. 4 is an exemplary interface that may be used in connection with the system of FIG. 1 and/or the method of FIG. 3 to create payment account transactions and associated messages; and

FIG. 5 is an exemplary interface that may be used in connection with the system of FIG. 1 and/or the method of FIG. 3 to display messages associated with payment account transactions.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

At various organizations, causes, events, and other locations (broadly, all events), participants/attendants often make use of modern technology to access networks, contribute donations, or make other purchase transactions. Applications on the participants' mobile devices may enable the participants to select particular events and make desired transactions (e.g., donations, purchases, etc.) in connection with the events, or otherwise effect transactions for products being offered. Often, the participants may also like to share messages in support of the events with (or provide advertising to) other participants at the events, or with users of social media outside the events.

Systems and methods of the present disclosure enable the participants to make payment account transactions at the events (e.g., donations, product purchases, etc.), and to provide associated messages therewith for display at the events and/or on social media associated with the events (or otherwise). The messages are then shown on community message feeds for viewing by other participants at the events, and/or by social media supporters of the events. The message feeds may also include other related social media posts, news articles, and other related content (e.g., video content of other activities such as a sporting event, etc.). As such, the systems and methods herein generally enable participants to take an active part in the events, not just through the transactions, but also through customized messages spread throughout the events and social media sources. In addition, the participants performing the transactions may include hashtags to link their messages, as posts, to proper topics and, optionally, provide images to go with the messages.

It should be appreciated that the present disclosure is not limited in application to any particular events, but is generally applicable to multiple various different types of activities. For example, the systems and methods herein may enable users to effect donations at charitable events. In addition, the systems and methods herein may enable users to effect payment account transactions in exchange for advertising space on dynamic advertising boards or screens (e.g., at various events; at point of sale displays at airports, malls, hotels, vending machines, or the like (all broadly referred to as events herein); etc.). Other applications are also available, as will be apparent through the description herein.

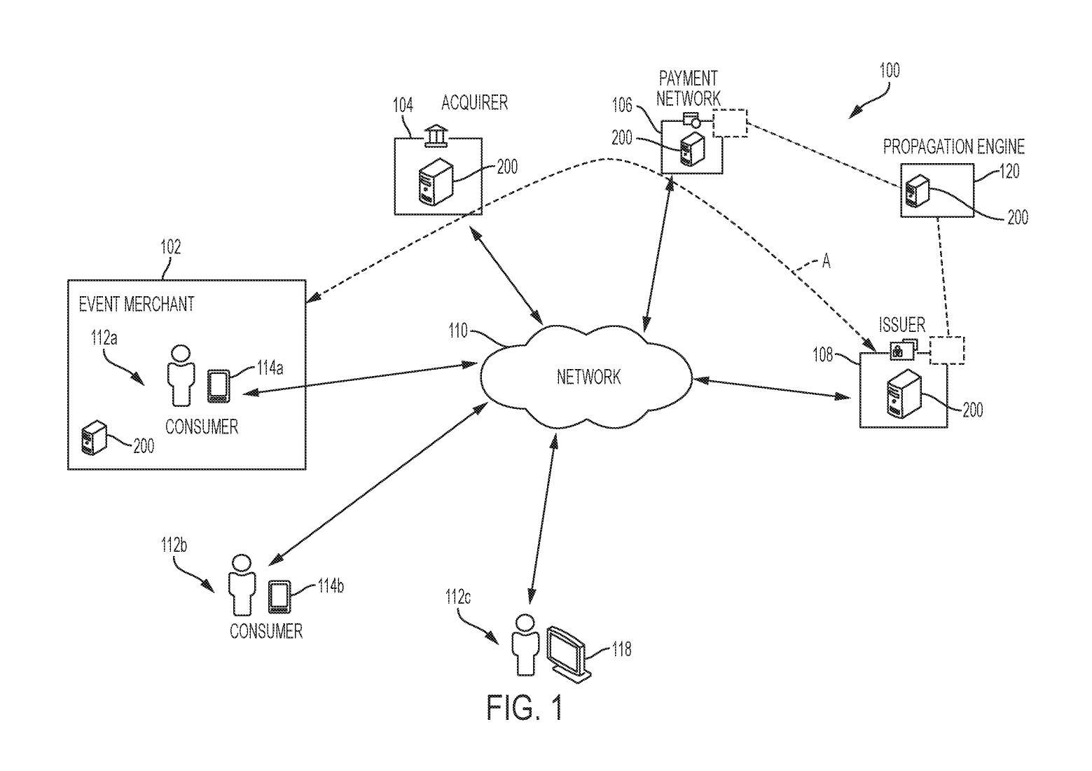

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, processing of payment account transactions, transmittal of messages, etc.

The system 100 generally includes an event merchant 102, an acquirer 104, a payment network 106, and an issuer 108, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which may provide interconnection between one or more of the event merchant 102, the payment network 106, and consumers 112a-c, etc.

The event merchant 102 is generally associated with one or more organizations, causes, or events, etc. to which the event merchant 102 enables consumers (e.g., consumers 112a-c) to effect transactions in connection with the particular organizations, causes, or events. In turn, the consumers are then allowed to submit various messages for display at/by the event merchant 102 (or otherwise on social media). The event merchant 102 may provide physical locations to enable the consumers to make the transactions, and/or may provide information describing the process of making such transactions and providing such messages to the consumers.

It should be appreciated that, while only one event merchant 102 and three consumers 112a-c are illustrated in the FIG. 1 for ease of reference, multiple event merchants and/or consumers may be added in the system 100, whereby there may be many different consumers effecting transactions to a variety of different events at a variety of different event merchants. In addition, event merchant 102 may represent a persistent event merchant (e.g., a second-hand clothing store, a soup kitchen, blood bank, a sporting franchise, a mall, a hotel, etc.) or a temporary event merchant (e.g., a charity fund drive, charity dinner, a concert, etc.).

In some embodiments, the consumers 112a-c are able to fund transactions with the event merchant 102 via one or more payment accounts. Use of a payment account to fund such transactions may be authenticated by providing the correct information to the event merchant 102 (e.g., a primary account number (PAN), expiration date, account holder name, etc.). The account information may be manually provided by the consumers 112a-c or it may be provided through other means, such as by swiping a credit card through a magnetic card reader or presenting data for an electronic wallet via portable communication devices associated with the consumers 112a-c.

As an example, the consumer 112a, while at the event merchant 102, may initiate a transaction with the event merchant 102 for a monetary donation to the event merchant 102 (or to a donation-based organization associated with the event merchant 102), for example, by presenting a payment device associated with the consumer's payment account to the event merchant 102 (e.g., a credit card, a debit card, a fob, a smartcard, a web-based (or network based) e-wallet application, etc.). In turn, the event merchant 102 submits an authorization request (broadly, a transaction message) to the acquirer 104 (associated with the event merchant 102 and/or associated donation-based organization) for the transaction, along path A in FIG. 1, to determine whether the payment account is in good standing and whether there is sufficient funds and/or credit to cover the transaction. The acquirer 104 communicates the authorization request with the issuer 108 (associated with the consumer's payment account) along path A, through the payment network 106, such as, for example, through MasterCard®, VISA®, Discover®, American Express®, etc. In turn, if approved, an authorization reply or response (indicating the approval of the transaction) (broadly, a transaction message) is transmitted back from the issuer 108 to the event merchant 102, along path A, thereby permitting the event merchant 102 to complete the transaction. The transaction is later cleared and/or settled (via appropriate transaction messages such as clearing messages and/or settlement messages) by and between the event merchant 102, the acquirer 104, and the issuer 108 (by appropriate agreements). If the transaction is declined, however, the authorization reply (indicating a decline of the transaction) is provided back to the event merchant 102, thereby permitting the event merchant 102 to halt or terminate the transaction.

While the above transaction is described in connection with a donation to the event merchant 102, it should be appreciated that other transactions may be performed between the consumer 112a and the event merchant 102. For example, the consumer 112a may purchase products from the event merchant 102, may transact with the event merchant 102 in exchange for advertising, etc.

In any case, transaction data is generated, collected, and stored as part of the above interactions among the event merchant 102, the acquirer 104, the payment network 106, the issuer 108, and the consumers 112a-c (and included in the various transaction messages). The transaction data represents at least a plurality of transactions, for example, authorized transactions, cleared and/or settled transactions, attempted transactions, etc. The transaction data, in this exemplary embodiment, is stored at least by the payment network 106 (e.g., in a data structure associated with the payment network 106, etc.). Additionally, or alternatively, the event merchant 102, the acquirer 104 and/or the issuer 108 may store the transaction data, or part thereof, in a data structure, or transaction data may be transmitted between parts of system 100 as used or needed. The transaction data may include, for example, primary account numbers (PANs) for consumers involved in the transactions, tokens associated with the transactions, amounts of the transactions, an ID for the event merchant 102, transaction category codes, dates/times of the transactions, donation descriptions or identifiers, etc. It should be appreciated that more or less information related to transactions, as part of either authorization or clearing and/or settling, may be included in transaction records and stored within the system 100, at the event merchant 102, the acquirer 104, the payment network 106 and/or the issuer 108.

With continued reference to FIG. 1, the consumers 112a-b are associated with communication devices 114a-b, respectively, and the consumer 112c is associated with display device 118.

In this exemplary embodiment, the communication devices 114a-b are portable communication devices, such as, for example, smartphones, tablets, laptops, etc. The communication devices 114a-b may include, or may be associated with, internet-based (or network-based) transaction applications (e.g., as stand-alone applications or in connection with e-wallet applications, etc.), or other applications that allow the consumers 112a-b to facilitate transactions to the event merchant 102, and which may include unique app identifiers or App IDs. In connection therewith, the communication devices 114a-b may be configured, by the applications, to further interact with a propagation engine 120 to deliver and receive information about the consumers' transactions with the event merchant 102 (and potentially other event merchants) and the like. This will be described in more detail hereinafter.

In addition, the display device 118 may be a device that is capable of displaying images, text, etc. and receiving display content via the network 110. While illustrated as a monitor in FIG. 1, the display device 118 may be, for example, a smartphone, a tablet, a laptop, a desktop computer with monitor, a television, a projector and screen, an “electronic ink” screen device, etc. The display device 118 may also include, or may be associated with, an internet-based (or network-based) display application which may include a unique app identifier or App ID. The display device 118 may be configured, by the display application, to interact with the propagation engine 120 to receive information associated with the event merchant 102 (and potentially other event merchants) for display. While only one display device 118 is illustrated in FIG. 1, it should be understood that any number of display devices may be included in the system 100.

Further, while one acquirer 104, one payment network 106, and one issuer 108 are illustrated in FIG. 1, it should be appreciated that any number of these entities (and their associated components) may be included in the system 100, or may be included as a part of systems in other embodiments, consistent with the present disclosure.

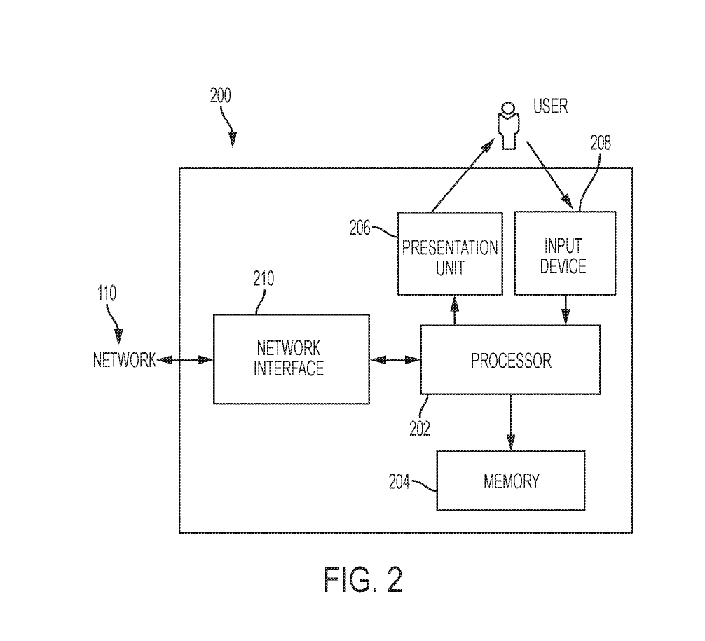

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the event merchant 102, the acquirer 104, the payment network 106, and the issuer 108 are illustrated as including, or being implemented in, computing device 200, coupled to the network 110. In addition, the propagation engine 120 in the system is illustrated as including, or being implemented in, computing device 200. Alternatively, however, the propagation engine 120 may be considered a software module that is executed by computing device 200 associated with the payment network 106, or other part of system 100. Further, the computing devices 200 associated with these parts of the system 100, for example, may include a single computing device, or multiple computing devices located in close proximity or distributed over a geographic region, again so long as the computing devices are specifically configured to function as described herein. In addition in the system 100, the communication devices 114a-b and the display device 118, which are associated with consumers 112a-c, respectively, may also be considered computing devices consistent with computing device 200 for purposes of the description herein.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, message information (e.g., messages, images, hashtags, etc.), consumer profiles, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 also includes a presentation unit 206 that is coupled to (and in communication with) the processor 202 (however, it should be appreciated that the computing device 200 could include output devices other than the presentation unit 206, etc.). The presentation unit 206 outputs information (e.g., consumer messages, etc.), visually, for example, to a user of the computing device 200 such as the consumers 112a-c in the system 100; users associated with one or more of the event merchant 102, the acquirer 104, the payment network 106, and the issuer 108; etc. It should be further appreciated that various interfaces (e.g., as defined by internet-based (or network-based) applications, websites, etc.) may be displayed at computing device 200, and in particular at presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices. In addition, the computing device 200 includes an input device 208 that receives inputs from the user (i.e., user inputs) such as, for example, transaction information, messages, etc. The input device 208 may include a single input device or multiple input devices. The input device 208 is coupled to (and in communication with) the processor 202 and may include, for example, one or more of a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the propagation engine 120 is specifically configured by computer executable instructions, to perform one or more of the operations described herein. While the propagation engine 120 is illustrated as an independent part of the system 100 in FIG. 1, it should be appreciated that the propagation engine 120 may be associated with and/or incorporated with (in whole or in part) other parts of the system 100 such as, for example, the payment network 106 or the issuer 108 (as indicated by the broken lines in FIG. 1), etc.

With that said, in connection with the exemplary transaction described above, the propagation engine 120 is configured to receive a message request relating to the transaction performed by the consumer 112a at the event merchant 102 (e.g., from the event merchant 102, etc.). The message request may be in the form of a data structure that includes payment account information for the consumer 112a and corresponding message information provided by the consumer 112a. The propagation engine 120 may be configured to further store the message request (e.g., in memory 204, etc.), to create and maintain consumer message content feeds, and to cause the corresponding transaction performed by the consumer 112a to be processed. In alternative embodiments, message requests may be sent to the propagation engine 120 from other consumers and other computing devices (e.g., communication device 114b, etc.). As an example, consumer 112a at the event merchant 102 may create the payment account transaction to the event merchant 102 using the communication device 114a as an enabled payment device. The communication device 114a may be configured by an application to then deliver a message request, including the created transaction, to the propagation engine 120, via the network 110.

The message request sent to the propagation engine 120, by the event merchant 102, for example, includes transaction information such as payment information for processing the transaction and message information, created by the consumer 112a, for propagation and display of the consumer's desired message. Upon receipt, the propagation engine 120 delivers the payment information, which may include a payment token for identifying and/or authenticating the transaction, to the payment network 106 for processing (e.g., via the acquirer 104 associated with the event merchant 102, etc.) as described above (and generally consistent with path A in FIG. 1).

The propagation engine 120 uses the message information created by the consumer 112a to create or add to one or more message feeds. A message feed may include one or more messages from consumers (including the consumer 112a), and it may also include other content associated with the cause(s) of the feed. For instance, a donation message feed associated with a charity event for finding a cure for cancer may include social media posts and/or news articles associated with the charity, recent cancer research, a famous philanthropist's contribution to a cancer cure, etc. Alternatively, an advertising message feed associated with a display at an airport may include advertising content created by the consumer 112a, in connection with the transaction at the event merchant 102 (which entails paying for the advertising). In any case, the propagation engine 120 may access the Internet (or other network) in order to find message feed content beyond the messages received from consumers to display. In order to find message feed content, the propagation engine 120 may execute keyword searches at various social media sources (e.g., Twitter, Facebook, Pinterest, Instagram, etc.), news sources, as well as keyword searches using social media hashtags, other handles, and/or RSS/Atom feeds from related websites.

The message content provided by the consumer 112a in the above example may include a name of the consumer 112a, an amount of the transaction (e.g., when the transaction includes a donation transaction, etc.), and a message provided by the consumer 112a. The consumer 112a may include the message with his/her transaction with the goal of the message being displayed on a particular message feed associated with the message and/or the event merchant 102, or on a particular message feed identified by the consumer 112a. The message may also include an image chosen by the consumer 112a, as well as hashtags to link the message to various social media topics.

The propagation engine 120 may maintain multiple message feeds, which includes updating the content of the message feeds as content is received and removing content that has grown stale (content that has been on the feed for longer than a defined time period, etc.). While message feeds may include repeated content, it should be understood that it is advantageous to include current content in the message feeds to capture the interest of viewers of the message feed. The time period for “staleness” of content may be defined within the propagation engine 120, and may include periods such as one hour, three hours, one day, one week, etc.

With continued reference to FIG. 1, separately in the system 100, computing devices, such as the display device 118 and the communication device 112b, may send requests to the propagation engine 120, via an application included thereon, for one or more message feeds. Or, the propagation engine 120 may push the message feeds to the computing devices 112b, 118. The requests may be sent at regular intervals (e.g., every hour, every twelve hours, every day, etc.) or irregular intervals (e.g., once previously requested message feed content has been shown, etc.). Each of the requests may include an identifier for selecting a particular requested message feed. The identifier may indicate a request for a specific message feed or it may indicate a request for message feeds associated with a specific topic and/or cause. For instance, the identifier may indicate a request for a message feed associated with a specific “cure for cancer” charity event, or it may indicate a request for all message feeds associated with “finding a cure for cancer” as a cause, or it may indicate a request for all message feeds associated with sporting events. In alternative embodiments, the computing devices may request all message feeds, or message feeds associated with a particular location or locations, or message feeds associated with particular activates, products, etc.

The computing devices may request the current message feed or a message feed for a particular timeframe (e.g., the message feed content from the past one hour, all message feed content up to the present, etc.). In some embodiments, the computing devices may display message feed content at an event, to an audience at the event, along with other content such as a streaming video of the event (e.g., such as at a baseball game, a football game, etc.). Or, the computing devices may display message feed content individually to consumers, such as consumer 112b via communication device 114b. The content of a consumer's individual feed may be determined based on preferences of the consumer, history of the consumer's participation at events, the consumer's individual location (e.g., a particular room at an event, a particular section or seat in an arena, a particular neighborhood, a particular mall, etc.). It should be understood that the computing devices send requests for message feeds associated with the event or event merchant 102 frequently in order to provide observing consumers/audience members with the most up-to-date content. The consumer could send more granular location data, such as a seat at a game, and a message feed could be filtered by location. For example, there could be a feed from courtside at a basketball game, a feed from outside the stadium, and/or a feed from fans at their homes.

In some embodiments, the propagation engine 120 may include or provide a dashboard application, to the event merchant 102, that displays incoming transactions from consumers (e.g., donations, product purchases, etc.) in real-time (including from the consumer 112a). The dashboard may display transaction amounts along with associated messages as they arrive at the propagation engine 120 and are processed. The dashboard may also display attached images. The dashboard enables the event merchant 102 to monitor transaction and message traffic through the propagation engine 120. While monitoring traffic through the propagation engine 120, the event merchant 102 may approve and/or disapprove content prior to it being added to a message feed. The event merchant 102 may disapprove content due to profanity, offensiveness, bad taste, or the like. Additionally, the dashboard may enable the event merchant 102 to monitor transaction amounts raised (e.g., donation amounts when the transactions involve donation transactions, etc.), as well as other statistical information associated with an event.

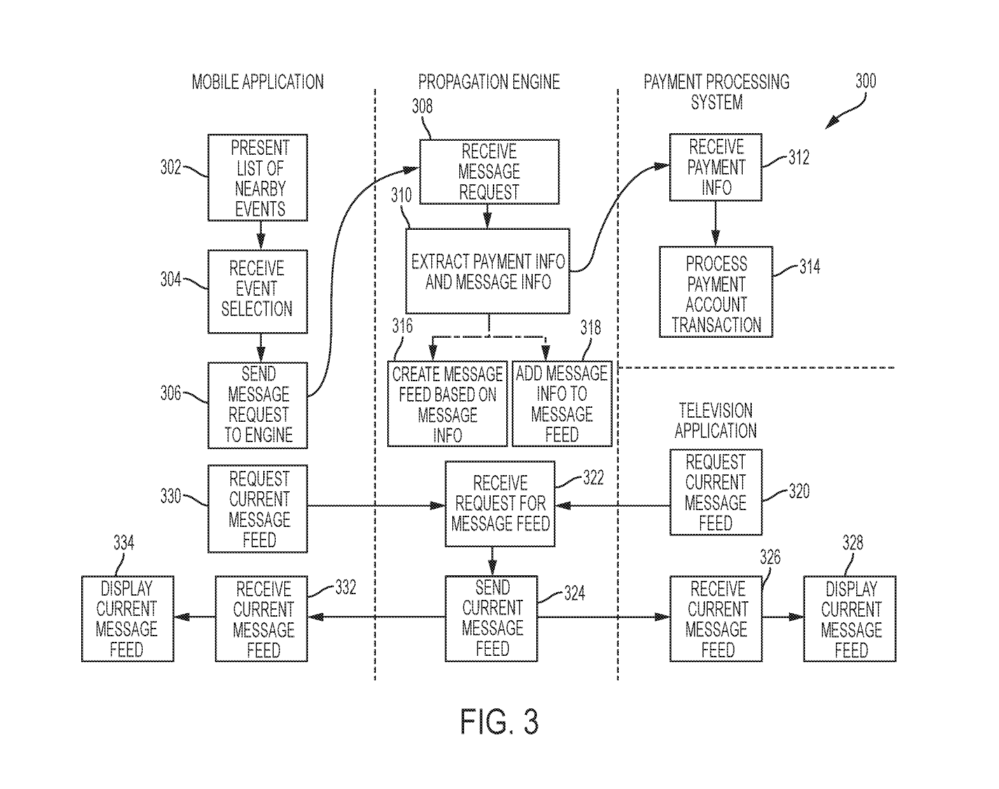

FIG. 3 illustrates an exemplary method 300 in accordance with the present disclosure for creating payment account transactions and associated messages, processing the transactions, and distributing the messages. In particular, the method 300 describes creation of a payment account transaction by a consumer via a mobile application, propagation of an associated message from the consumer by the propagation engine 120, processing of the transaction by the system 100, and display of a message feed by a television application or the mobile application through which the consumer's message is distributed. In connection therewith, the exemplary method 300 is described as generally implemented in the propagation engine 120, with additional reference to other parts of the system 100. However, it should be understood that the method 300 is not limited to this configuration, as the method 300 may be implemented in other parts (or combination of parts) of the system 100 and/or other ones (or combinations of ones) of the computing devices 200 in system 100, or in multiple other computing devices. As such, the methods herein should not be understood to be limited to the exemplary system 100 or the exemplary computing device 200, and likewise, the systems and the computing devices herein should not be understood to be limited to the exemplary method 300.

At 302 in the method 300, a mobile application may be executed on a computing device, such as communication device 114a, to provide consumer 112a with a list of nearby events, including their associated event merchants, which may be accepting messages (and associated transactions). As previously described, the events may include, without limitation, charity events at which the consumer 112a can make donations and provide associated donation messages, sporting events at which the consumer 112a can provide messages for display at the events for a charge, retail events at which the consumer 112a can provide a message upon purchasing a product, advertising events (e.g., at a mall, at an airport, etc.) at which the consumer 112a can provide an advertising message to be displayed at particular advertising media for a charge, etc.

The list of events may be generated by the mobile application using Global Positioning System (GPS) technology of the computing device, along with known locations of the nearby events. In addition, the list of events may be organized by types of the events, as desired, and may be searchable by the consumer 112a. The events may be provided to the consumer 112a on a screen, or other similar presentation unit (e.g., presentation unit 206, etc.), of the communication device 114a. The entries of the list may include information about the events, including the name of each event, the distance of the event's location from the communication device 114a, based on GPS technology, a description of the event, contact information for the event, etc. The mobile application is configured to enable the consumer 112a to select an event to which he/she would like to interact. In alternative embodiments, the list of events may be based on other factors, rather than location, such as a keyword search by the consumer 112a, the consumer's preferences, the consumer's transaction history, etc.

In turn, the mobile application receives information from the consumer 112a, at 304, regarding a desired event to which the consumer 112a wishes to interact. The event information may include a selection of one of the events from the list or it may include a particular event provided by the consumer 112a. In either case, the event information generally includes an indicator of the selected event, an amount associated with providing a message at the selected event, a message to include with the corresponding payment account transaction, a picture to include with the transaction, hashtags to link to the message, etc. The mobile application also receives payment information from the consumer 112a, including a payment account number, other payment account credentials, etc. The event information and payment information are received by the mobile application through an interface, such as via a keyboard, touchscreen, or other input device (e.g., input device 208, etc.), as described above. Further, in various embodiments, the payment information may be received by the mobile application via an electronic wallet.

When the event information and payment information are collected, the mobile application sends the information to the propagation engine 120, at 306, as a message request (either directly, or via the event merchant associated with the selected event). The information may be sent via a network, such as network 110. The mobile application may be configured to send information to the particular propagation engine 120, or there may be more than one propagation engine and the mobile application may send the information to a propagation engine based on the selected event, event information, or payment information.

At 308, the propagation engine 120 receives the message request, and at 310, the propagation engine 120 extracts the payment information and the event message information from the received request. The payment information, which may include a payment token used to identify the associated transaction, is delivered to a payment processing system (e.g., including the acquirer 104, the payment network 106, and the issuer 108, etc.), while the event message information is retained by the propagation engine 120. In some embodiments, the payment token is generated by the mobile application at the consumer's communication device 112a, or it may be generated by the propagation engine 120 communicating with the payment network 106 based on the received payment information. The generated payment token is used for secured data transmittal for processing payment of the transaction.

The payment processing system receives the payment information, at 312, and processes the payment account transaction, at 314, to the user's payment account in the manner described above for system 100 (e.g., along path A in FIG. 1, via the acquirer 104, the payment network 106, and the issuer 108; etc.). When the payment information includes the payment token that identifies the transaction, the payment token may be used by the payment processing system to identify the transaction, the consumer 112a associated with the transaction, and the consumer's payment account, in order to process the transaction. In some embodiments, the propagation engine 120 may wait for confirmation that the transaction has been authorized, for example, before processing the associated message.

With continued reference to FIG. 3, when a message feed for the selected event, as identified in the message information, has not yet been created, the propagation engine 120 creates a message feed associated with the event, at 316, and adds the message information received from the user to the feed. Alternatively, if a message feed for the event already exists, the propagation engine 120 adds the message information to the existing message feed, at 318.

The message feed for the event may include a variety of content pertaining to the event. For instance, a message feed may include messages associated with the event from other consumers at the event, and it may also include social media posts, news articles, live feeds, etc. which are associated with the event, as described above. The propagation engine 120 may populate a message feed with content which has been tagged, or “hash-tagged,” with keywords that pertain to the event. Alternatively or additionally, the propagation engine 120 may include content which contains keywords associated with the event.

The content of the message feed may be limited to a recent timeframe. For instance, content may be added to a message feed if it was posted and/or sent to the propagation engine 120 later than a defined time threshold (e.g., one day ago, three days ago, one week ago, one hour ago, etc.). The message feed content may be limited in other ways, such as requiring a minimum transaction amount (e.g., a minimum donation, a minimum purchase, etc.), or requiring an image to be included with a message. Messages, social media posts, and other message feed content may be filtered for certain words, phrases, images, etc.

Separately in the method 300, a television application, which may be executed on a computing device, such as the display device 118, is configured to request a current message feed from the propagation engine 120, at 320. The request may include a computing device identifier or television application identifier, as well as information identifying the message feed being requested. In some embodiments, the television application requests all current message feeds. The request may be delivered to the propagation engine 120 via network 110.

Upon receiving the message feed request, at 322, the propagation engine 120 sends the current message feed associated with the request, at 324, to the television application. In connection therewith, the propagation engine 120 may process the message feed request upon reception, which may include confirming that the requesting television application is authorized to access the requested message feed.

At 326, the television application receives the requested current message feed and displays the message feed, at 328. Displaying the message feed may take place over a period of time, with the displayed content changing at intervals throughout the time period. For instance, if the message feed includes six different messages with images, the message feed may display each message and image for five seconds before moving on to the next message and image. Displaying the message feed in this manner would require thirty seconds. In addition, the message feed may be displayed on loop, so that, when the feed is finished, it starts over from the beginning. In alternative embodiments, the content of the message feed may be displayed in a random or pseudo-random order. In some embodiments, messages may be streamed in motion across the display of the television application, and related images may be displayed when the associated message is on screen or mostly on screen. The television application may store received feeds until they can be displayed.

In some embodiments, the mobile application may also request a current message feed, at 330, for example, relating to an event selection from the consumer 112a at 304, etc., and may receive a current message feed, at 332, and display the current message feed, at 334. The process of the mobile application may function in a substantially similar way to the television application described above.

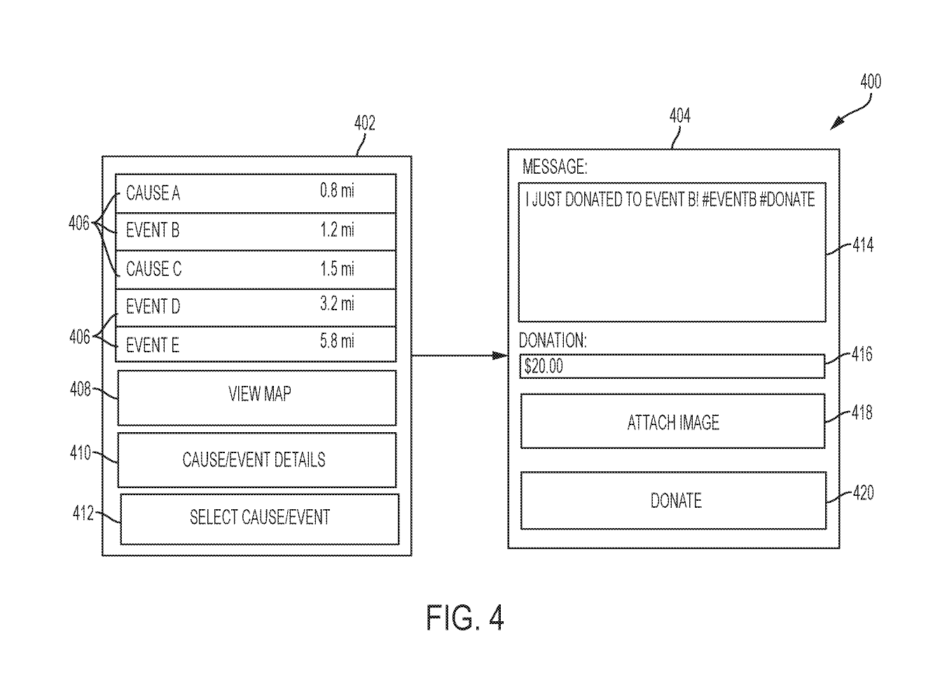

FIG. 4 illustrates an exemplary user interface 400 suitable for use with the mobile application described above, for example, for display at the consumer's communication device 114a and for selecting an event and creating a payment account transaction and associated message for the selected event. The illustrated user interface 400 generally includes an event selection screen 402 and an event creation screen 404.

In the embodiment of FIG. 4, the event selection screen 402 displays a list of multiple events 406. The events 406 may also include information about the events, for example, if the events are donation-type events, product purchase-type events, advertising-type events, etc. The event information may further include the name of the event and a distance to the event. In other embodiments, the event information may include additional information about the events, such as a general description of the event, a donation goal for donation-type events, etc.

The event selection screen 402 also includes a view map button 408 that may enable the consumer 112a to view the listed events 406 on a map at the consumer's communication device 114a. Interacting with the view map button 408 may cause a map (not shown) to be displayed on the interface showing the location of each of the listed events 406 as well as the current location of the communication device 114a on which the user interface 400 is being displayed. The map may enhance the consumer's ability to find a particular one of the events 406 that he/she wants to attend.

The event selection screen 402 further includes an event details button 410. The event details button 410 may cause the display of additional details about a selected one of the events 406. The event details may include a detailed description of the event, an address and other contact information for the event, etc.

Finally, the event selection screen 402 includes a select event button 412. When the consumer 112a has highlighted one of the events 406 with which he/she would like to interact, he/she may actuate the select event button 412 to display the event creation screen 404.

The event creation screen 404 includes a message section 414 which enables the consumer 112a to provide a personalized message to go along with a transaction to the event. This message may include text as well as hashtags, which link the message to related topics on social media. In FIG. 4, the message relates to a donation transaction made to Event B (a donation-type event). The event creation screen 404 includes a payment section 416 for the consumer 112a to enter a desired transaction amount. In some embodiments, the payment section 416 may include additional payment information from the consumer 112a, such as a payment account number and other payment account credentials. In addition, in some embodiments, the payment section 416 may include predefined transaction amounts, for example, set by the event merchant 102, etc. (e.g., in connection with advertising messages, etc.), that are required for payment in order for the user to transmit a message (via the message section 414). Further, the consumer 112a may provide more granular location data, such as a seat at a game, a nearby sports bar, directly outside the stadium, or a feed from other consumers' homes.

In addition at the event creation screen 404, an attach image button 418 enables the consumer 112a to include an image with the message, such that the image will be displayed when the message is displayed on a message feed, as described above. Interacting with the attached image button 418 may access images stored on the communication device 114a and/or enable the consumer 112a to take a photo with a camera of the communication device 114a.

When the consumer 112a has completed information entry for the transaction, he/she may interact with button 420 to finalize the transaction and the message. The button 420 causes the created transaction and message to be delivered to the propagation server 120, again as described above.

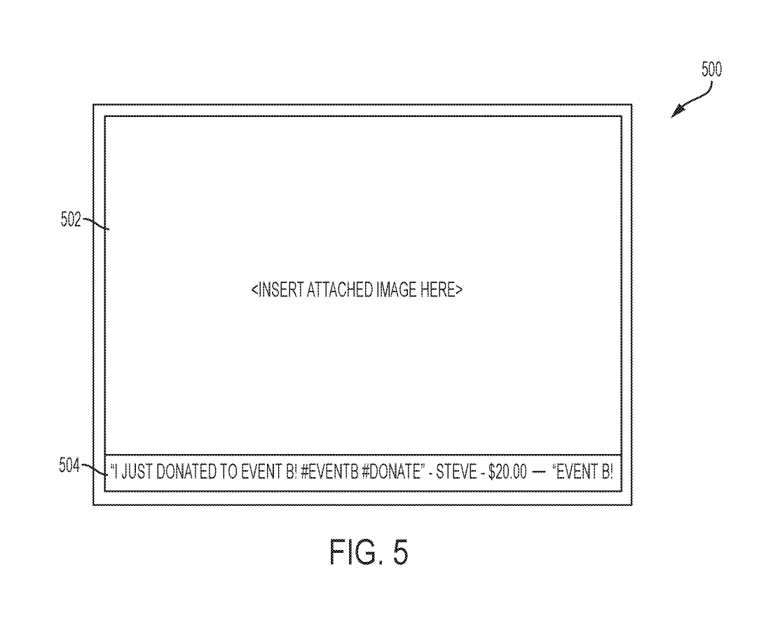

FIG. 5 is an exemplary user interface 500 for a television application that may be used in conjunction with display device 118 of the system of FIG. 1. For instance, a message feed may be displayed on the display device 118 via the television application, as described above. The user interface 500 displays information associated with one or more events in the form of a message feed, including messages, images, social media content, related articles, and the like. The user interface 500 includes an image section 502 and a message section 504. The image section 502 may display recent messages associated with the event, images associated with the recent messages, images from social media and related articles, or it may display a live feed of activities taking place at the event (e.g., live action at a sporting event, an advertising message, etc.). In FIG. 5, the message section 504 is displaying a message from a consumer named “Steve” along with Steve's donation of $20.00. In the embodiment of FIG. 5, the message section 504 scrolls messages across the screen at a defined rate, with the image of the image section 502 being updated with associated images as the messages scroll across. The beginning of the next message can be seen in the message section 504 as the message from Steve is about to scroll off of the screen. It should be understood that, while the user interface 500 is for a television application, similar interfaces may be used to display donation information on mobile devices and other communication devices.

In view of the above, the systems and methods herein may permit propagation of messages associated with payment account transactions. In particular, users may generate transactions at events and include personalized messages with the transactions that are then propagated, by a propagation engine, for display.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a message request associated with an event; (b) extracting payment information and message information from the message request; (c) causing the payment information to be processed; (d) creating a message feed related to the event when a message feed related to the event does not exist; (e) adding the message information to a message feed related to the event when the message feed related to the event exists; and (f) causing, in response to a message feed request, the message feed to be delivered, whereby the message feed is displayed at an event merchant associated with the event.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for propagating messages associated with an event, the method comprising:
receiving, by a computing device, a message request associated with an event;
extracting, by the computing device, payment information and message information from the message request;
causing, by the computing device, the payment information to be processed;
creating, by the computing device, a message feed related to the event when a message feed related to the event does not exist;
adding, by the computing device, the message information to a message feed related to the event when the message feed related to the event exists; and
causing, by the computing device, in response to a message feed request, the message feed to be delivered, whereby the message feed is displayed at an event merchant associated with the event.

2. The computer-implemented method of claim 1, wherein the message information includes a message and an image.

3. The computer implemented method of claim 1, wherein the message information includes at least one hashtag; and
wherein creating a message feed related to the event includes adding content associated to the at least one hashtag to the message feed.

4. The computer implemented method of claim 1, wherein causing the payment information to be processed includes verifying an authorization of a payment, and wherein the message information is added to the message feed only when the payment authorization is verified.

5. The computer-implemented method of claim 1, further comprising causing, by the computing device, a real-time dashboard to be displayed, the dashboard displaying payment information and message information.

6. The computer-implemented method of claim 1, further comprising removing, by the computing device, content from the message feed when the content has been in the message feed for longer than a defined time period.

7. A system for propagating messages, the system comprising:
a processor;
a network interface in communication with the processor;
a memory in communication with the processor, the memory including executable instructions that, when executed by the processor, cause the processor to:
receive a message request via the network interface, the message request including message information and payment information;
extract the message information from the message request;
append the extracted message information to a message feed related to the message information;
receive a request for access to the message feed; and
cause the message feed to be transmitted via the network interface in response to the request for access to the message feed.

8. The system of claim 7, wherein the executable instructions, when executed by the processor, further cause the processor to:
extract the payment information from the message request; and
generate an authorization request for a transaction based on the payment information.

9. The system of claim 8, further comprising a payment processing system in communication with the processor via the network interface, the payment processing system configured to receive the authorization request from the processor and process the transaction.

10. The system of claim 9, wherein the payment processing system includes at least one of a payment network, an acquirer, and an issuer.

11. The system of claim 8, wherein the payment information includes at least a payment account number and a payment amount.

12. The system of claim 7, wherein the executable instructions, when executed by the processor, further cause the processor to:
extract the payment information from the message request; and
cause the payment information to be delivered to a payment processing system.

13. The system of claim 7, further comprising a computing device in communication with the processor via the network interface, the computing device including a display interface and executable instructions that, when executed by the computing device, cause the computing device to:
transmit the request for access, via the network interface, to the processor; and
display the message feed on the display interface.

14. The system of claim 13, wherein, in connection with displaying the message feed on the display interface, the executable instructions, when executed by the processor, further cause the processor to display messages and display images associated with the messages.

15. The system of claim 7, wherein the message feed is transmitted at regular time intervals.

16. The system of claim 7, wherein the message feed includes at least one of social media content and news article content.

17. The system of claim 7, wherein the executable instructions, when executed by the processor, further cause the processor to transmit multiple events for which messages may be propagated; and
wherein, in connection with receiving the message request via the network interface, the executable instructions, when executed by the processor, cause the processor to receive a selection of one of the multiple events and receive the message request in connection with said selected event.

18. The system of claim 17, wherein the executable instructions, when executed by the processor, further cause the processor to identify the multiple from a set of nearby events based on GPS information.

19. A non-transitory computer readable storage media including executable instructions for propagating messages, which when executed by at least one processor, cause the at least one processor to:
receive a message request associated with an event, the message request including payment information and message information;
extract the payment information from the message request and cause the payment information to be processed by a payment processing system;
extract the message information from the message request; and
when a payment account transaction including the payment information is authorized, add the message information to a message feed related to the event.

20. The non-transitory computer readable storage media of claim 19, wherein the payment processing system includes at least one of a payment network, an acquirer, and an issuer.
